(19) United States
(12) Patent Application Publication
(10) Pub. No.: US 2023/0269009 A1
(43) Pub. Date: Aug. 24, 2023

(54) SIGNAL-QUALITY DETERMINATION FOR PRESENCE SENSING

(71) Applicant: SIGNIFY HOLDING B.V., EINDHOVEN (NL)

(72) Inventors: LEENDERT TEUNIS ROZENDAAL, VALKENSWAARD (NL); HUGO JOSÉ KRAJNC, EINDHOVEN (NL); BOZENA ERDMANN, AACHEN (DE); ROBERT CORNELIS HOUTEPEN, BREDA (NL); PETER DEIXLER, ARLINGTON, MA (US)

(21) Appl. No.: 18/017,138

(22) PCT Filed: Jul. 13, 2021
(86) PCT No.: PCT/EP2021/069506

§ 371 Date: Jan. 20, 2023

Related U.S. Application Data
(60) Provisional application No. 63/054,428, filed on Jul. 21, 2020.

(30) Foreign Application Priority Data
Jul. 30, 2020 (EP) 20188668.6

(51) Int. Cl. H04B 17/318

(52) U.S. Cl. CPC H04B 17/328; H04W 84/12

(57) ABSTRACT

The present invention is particularly directed to a signal-quality determination device (300) that comprises a transceiver unit configured to provide a wireless beacon-request signal as a single-hop broadcast signal indicative of a request to any wireless communication device (312.1, 312.2, 340) within a single-hop distance from the signal-quality determination device and belonging or not to a wireless communication network 350 to which the signal-quality determination device belongs, to provide a respective beacon-response signal upon reception of the beacon-request signal, and to receive the beacon-response signals. The signal-quality determination device is configured to determine beacon signal-quality data (SQ) indicative of a received-signal quality, e.g. RSSI of the beacon-response signal, or a channel-state CSI of a respective wireless communication link. The signal-quality determination device is suitable for enabling a reduction of complexity in a radiofrequency based presence or movement sensing function.

### FIELD OF THE INVENTION

The present invention is directed to a signal-quality determination device, to a sensing-device, to a wireless communication arrangement, to respective methods for operating the signal-quality determination device, the sensing-device, and the wireless communication arrangement, and to a computer program.

### BACKGROUND OF THE INVENTION

U.S. Pat. No. 10,217,346 B1 discloses a method for presence detection. In the disclosed method, a computing device receives, from a wireless receiver, first data indicative of radio frequency channel properties of a first communication link between the wireless receiver in a first device and a wireless transmitter in a second device. The first and the second device are located in a building. The computing device further executes a neural network to process the first data to distinguish humans from stationary objects within the building. The computing device transmits result data indicative of the presence to at least one of the first device or the second device.

US 2012/025849A1 discloses a method to detect an object in an area which includes forming a wireless network among a plurality of nodes, each of the nodes being configured to generate an electromagnetic field (EMF) in the area and determining changes in the EMF between two nodes based on: a first difference in received signal strength values between a previously determined received signal strength value and a currently determined received signal strength value, a second difference in received signal strength values between the currently determined received signal strength value and an average received signal strength value and a third difference in link quality values between a previously determined link quality value and a currently determined link quality value.

### SUMMARY OF THE INVENTION

It would be beneficial to provide an alternative to existing methods of determining properties of a communication link.

A first aspect of the present invention is formed by a signal-quality determination device that comprises a transceiver unit suitable for communicating with external wireless communication devices in accordance with a wireless communication protocol in a wireless communication network. The transceiver unit comprises a transmitter unit configured to provide a wireless beacon-request signal as a single-hop broadcast signal in accordance with the wireless communication protocol. The beacon-request signal is a signal indicative of a request to any external wireless communication device within a single-hop distance from the signal-quality determination device to provide, upon reception of the beacon-request signal, a respective beacon-response signal that is also in accordance with the wireless communication protocol and that comprises device-identification information pertaining to the respective wireless communication device. The transceiver unit also comprises a receiver unit configured to receive the beacon-response signals provided by any wireless communication device and sent in response to the beacon-request signal.

The signal-quality determination device further comprises a signal-quality determination unit that is connected to the receiver unit and configured to determine and provide beacon signal-quality data indicative of a received-signal quality. The beacon signal-quality data can therefore be indicative of a received-signal strength of the beacon-response signal, or indicative of a channel-state of a wireless communication link between that wireless communication device providing the beacon response signal and the signal-quality determination device, or of any other suitable received-signal quality measure.

The signal-quality determination device of the first aspect advantageously enables a simple signal-quality determination using a beacon-request/response mechanism. The mechanism is implemented in the wireless communication protocol. It advantageously allows deriving beacon signal-quality data irrespectively of whether the beacon response is provided from a wireless communication device within or outside the wireless communication network. In contrast, known wireless communication devices only use communication channels that are already established within a wireless communication network. The inventors, however, have recognized that the capability of the beacon-request/response mechanism can be further exploited for signal-quality determination in an exchange between wireless communication devices irrespective of their current association to a wireless communication network. Thus, the beacon signal-quality advantageously provides information on signal quality even without a dedicated association to an established communication link.

The external wireless communication devices are communication devices that may or may not be part of the wireless communication network but that independently thereof are configured to operate in accordance with the wireless communication protocol and thus, to respond to the reception of the wireless beacon-request signal by providing the beacon-response signal.

The signal-quality determination device of the first aspect is thus suitably configured to determine and provide signal-quality data. The signal-quality data is determined using the responses provided by the wireless communication devices to wireless beacon-request signal provided by the signal-quality determination device. The beacon-request signal provided by the transmitter unit are indicative of a request to any external wireless communication device within a single-hop distance from the signal-quality determination device to provide a respective beacon-response signal. Thus, according to the wireless communication protocol, any communication device that receives the beacon-request signal is configured to provide, in response to receiving the beacon-request signal, a respective beacon-response signal. The beacon-response signal includes, in accordance to the wireless communication protocol, device-identification information that enables an identification of the wireless communication device.

In the following, embodiments of the signal-quality determination device of the first aspect of the invention will be described.

In an embodiment, the signal quality determination device is configured to determine and provide the signal quality data of the beacon-response signals without analyzing the content of the beacon apart from for identifying the wireless device that has provided the respective beacon-response signals. Thus, the received beacon-responses are not used for the typical intended function of joining or trying to join a wireless communication network.

In a particular embodiment, the signal-quality determination device is configured to provide the beacon-request signal when connected to a wireless communication network. In another embodiment, the signal-quality determination device is additionally or alternatively configured to provide the beacon-request signal when it is not connected to a wireless communication, for instance for determining the signal-quality data in a stealth or covered operation mode with respect to the wireless communication network.

In a particular embodiment, the signal-quality determination device comprises a network-detection unit configured to ascertain that the signal-quality determination device is part of a wireless communication network and to provide a connection-signal indicative thereof. In this preferred embodiment, the transmitter unit is configured to receive the connection-signal and to provide the wireless beacon-request signal in response to the connection-signal indicating that the signal-quality determination device is connected to the wireless communication network. Preferably, the wireless beacon-request signal is provided repeatedly to determine a development of the beacon-signal quality over time. The use of the beacon-request signal to this purpose while the signal-quality determination device is connected with a wireless communication network is contrary to the usual practice of the prior art, which uses beacon request signals in a not-connected state.

Any of the embodiments described below can additionally comprise the network-detection unit and the transmitter unit described above.

In an embodiment, the transceiver unit is configured to provide the wireless beacon-request signal as a beacon-request in accordance with the IEEE 802.15.4 communication protocol or as a Beacon-Frame in accordance with the IEEE 802.11 communication protocol or in accordance with both communication protocols, for instance in devices having a dual radio system. A particular embodiment uses Zigbee as a suitable wireless communication protocol according to IEEE 802.15.4. Alternative embodiments use other communication protocols in accordance with IEEE 802.15.4 such as, but not limited to Thread and 6LoWPAN. Yet other embodiments are configured to communicate using more than one communication protocol, further including, in addition to the IEEE 802.15.4 based protocols, other protocols such as, Bluetooth, Bluetooth Mesh, Wi-Fi, etc.

One particular embodiment makes use of the IEEE 802.15.4 beacon request/response mechanism to trigger from the signal-quality determination device responses from all other surrounding IEEE 802.15.4 compatible communication devices. Zigbee is a suitable communication protocol based on IEEE 802.15.4, which defines a beacon request/response mechanism. The purpose of this mechanism is to allow a ‘new’ communication device to find other devices and thus join a wireless communication network. Usually, the ‘new’ communication device sends a beacon-request signal, basically indicating “is there anyone in RF-range?”. This beacon-request signal is a broadcast, single hop, message. According to the specifications: “The Destination Addressing Mode field shall be set to indicate short addressing, and the Source Addressing Mode field shall be set to indicate that the source addressing information is not present”. All the devices in single-hop distance of this ‘requesting’ device will hear this message and respond with a beacon-response signal.

Using the received beacon-response signals, the signal-quality determination device acquires signal strength information (RSSI) from the communication links between the signal-quality determination device and, in principle, all surrounding single-hop reachable IEEE 802.15.4 compatible communication devices.

In an embodiment, the device-identification information is advantageously used by the network-determination unit to identify whether those communication devices that have provided the beacon-response signal are or are not part of the same wireless communication network as the signal-quality determination device.

In this embodiment the signal-quality determination device further comprises a network-determination unit that is connected to the receiver unit and configured to determine, using the device-identification information, whether the respective received beacon-response signal is an inter-network response signal provided by a neighbor-communication device not belonging to the wireless communication network or an intra-network response signal provided by a transmitting wireless communication device belonging to the wireless communication network. In this sense, the inter-network response signal and the intra-network response signals are both beacon-response signals and only differ in the fact that the former is provided by a communication device, herein referred to as neighbor-communication device—that does not belong to the wireless communication network but nevertheless replies to the received beacon request signal and the latter is provided by a communication device, herein referred to as transmitting-communication device—that belongs to the wireless communication network.

The network-determination unit is additionally configured to provide to the signal-quality determination unit, a network-identification signal indicative thereof in the form of an inter-network-identification signal or an intra-network-identification signal respectively.

In this embodiment, the signal-quality determination unit is further connected to the network-determination unit and configured, using the received intra-network-identification signal or inter-network-identification signal, to determine the beacon signal-quality data as inter-network beacon signal-quality data or as intra-network beacon signal-quality data respectively and to provide, as the beacon signal-quality signal, an inter-network signal-quality signal or an intra-network signal-quality signal indicative thereof.

Thus, this particular embodiment is advantageously configured to determine and provide beacon signal-quality data from beacon-response signals provided by communication devices that are part of the wireless communication network, i.e., as respective intra-network signal-quality signal, and by those that are not part of the wireless communication network i.e., as respective inter-network signal-quality signal. The provision of both types of beacon signal-quality data enables for instance a distinction in terms of relevancy, since typically the communication devices belonging to the same wireless communication network are located closer and provide wireless signals that are received with relatively higher power amount than those signals provided by wireless communication devices belonging to a different wireless communication network. This is particularly relevant for so-called “true presence detection” where not only a relative variation but also an offset with respect to a previously calibrated measurement are evaluated.

In an embodiment, the signal-quality determination unit is configured to determine a number of beacon-response signals received in response to a given beacon-request signal that has been sent. In this embodiment, the transmitter unit comprises a transmission-power control unit connected to the signal-quality determination unit and configured to adapt a transmission power amount of the beacon-request signal in dependence on the determined number of beacon-response signals. In another embodiment, the transmission power amount is controlled in dependence on the determined inter-network beacon signal-quality data, in dependence on the intra-network beacon signal-quality data or in dependence on both.

Adapting, i.e. reducing or increasing, the transmission power amount of the beacon-request signal has a direct impact on a spatial volume within which the external wireless communication devices are able to receive the wireless beacon-request signal. The transmission-power control unit is connected to the signal-quality determination unit and it is therefore configured to increase or decrease the transmission power amount in dependence on the number of beacon-response signals received in response to a given beacon-request signal. In embodiments where the beacon-response signals cannot be univocally linked to a particular beacon-request signal, the number of beacon-response signals provided in response to a given beacon-request signal is assumed to be the number of beacon-response signals received within a predetermined time span after provision of the beacon-request signal. For instance, the embodiment comprising the transmission-power control unit is suitably configured to reduce the transmission power amount of the beacon-request signal if a number of received—beacon-response signals provided by the external wireless communication devices is greater than a predetermined value. Additionally, if the number of received beacon response signals provided by the external wireless communication devices is smaller than a predetermined value or the signal strength or the channel-state indicator is below a respective threshold amount, the transmission-power control unit is configured to increase the transmission power amount. Further, in another embodiment, if at maximum transmission power, the number of received beacon-response signals remains below a predetermined value, this can be used as an indication that the signal-quality determination device is placed at a location not particularly suitable for determining beacon signal-quality data.

In a particular embodiment, a body of the beacon-response signal comprises an indication of a received signal strength of the beacon-request signal, as determined by the communication device in accordance with the wireless communication protocol used and in dependence on the communication device providing the beacon-response signal. The transmission-power control unit of this embodiment is further configured to control the transmission power amount further using the indication provided by the wireless communication device.

In another embodiment, the signal-quality determination device further comprises a communication-device data ascertainment unit configured to ascertain communication-device data pertaining to one or more of those wireless communication devices that are within a single-hop distance from the signal-quality determination device, i.e. that are communicatively reachable by the signal-quality determination device within one hop. In this embodiment, the signal-quality determination device further comprises a beacon-response selection unit that is connected to the receiver unit and to the communication-device data ascertainment unit and that is configured to select, in accordance with at least one predetermined selection algorithm pertaining to the communication-device data, and to provide to the signal-quality determination unit only those of the received-beacon response signals that fulfil the selection criterion. For example, the predetermined selection algorithm is configured to select suitable wireless communication devices that are communicatively reachable within one hop are suitable-communication devices. Suitable communication devices are devices that, according to the predetermined determination algorithm are particularly suitable for determining the received signal strength or the channel state and to provide a respective suitability signal indicative thereof. Further, the signal quality determination unit is additionally configured to determine the beacon signal-quality data of only those beacon-response signals provided by the suitable communication devices.

The signal-quality determination device, when operating, receives beacon response signals from a collection of communication devices. This particular embodiment thus, enables a filtering mechanism for reducing the number of communication devices whose beacon-response signals have to be evaluated. A particularly suitable embodiment is configured to determine the inter-network beacon signal-quality data of only inter-network response signals provided by suitable-communication devices not belonging to the wireless communication network. For communication devices belonging to the same wireless communication network as the signal-quality determination device, either the signal-quality determination device or a network control node such as a gateway has access to a list with identifiers indicative of the respective communication devices or network nodes within the communication network. The signal-quality determination device is configured to exploit the available metadata on these communication devices for use in the predetermined determination algorithm, and which includes, for instance location information indicative of a position of the communication device, e.g., room, floor, an archetype or default transmission power of the beacon-response signal, etc. Thus for the communication devices in the same communication network useful information can be already derived, which is useful for determining how relevant the beacon signal-quality data is for an intended application, such as for example sensing of presence or movement. For neighbor communication devices that do not belong to the wireless communication network, such information may be lacking or some heuristics is applicable, which includes knowledge about the manufacturer, which is derivable from the organization unique identifier (OUI) in a MAC address. Other heuristics are using the personal area network (PAN) identifiers. For instance, when, in a building, two different sets of beacon-response signals are received that have respective PAN identifiers and a common OUI, this is an indication that it is likely that each PAN is associated to a different room or area or floor in the building, and grouping by PAN can be done. Another heuristic that is additionally or alternatively used in an embodiment is the RSSI level. Beacon signal-quality data provided by neighbor communication devices, referred to as inter-network beacon signal-quality data, and indicative of an RS SI value significantly lower than that determined from the beacon-response signals of other communication devices is in some embodiments ignored, since it is interpreted as an indication that the communication device is outside an intended detection area. In another example, a building with a parallel network, such as a heat ventilation and air-conditioning (HVAC) network, the identification or location information shared via the beacon-response signal, is shared with the wireless communication network, for example during a commissioning phase, so that this information is available for selecting suitable network nodes of the HVAC network.

In another embodiment, the transceiver unit is further configured to provide the wireless beacon-request signal including selection data indicative of a predetermined selection-condition to be fulfilled by any external wireless communication device for being eligible to provide the beacon-response signal.

Suitable selection-conditions include, but are not limited to, receiving the wireless beacon-request signal with a signal-power amount within a giving signal power range. For example, a received signal strength indication value (RSSI) being relatively close to the maximum transmission power amount is used as an indication that the communication device is relatively close to the signal-quality determination device, which for applications such as presence or movement sensing using signal-quality data is typically not desirable. However, RSSI values significantly lower than the maximum transmission power, but still within a predetermined range can be understood as an indication that the beacon-response signal is received fine and that the communication device and the signal quality communication device are located farther apart than in the previous case so that the beacon-response signal can be used for sensing purposes.

Particularly, a minimum signal power threshold is defined in the Enhanced Beacon Filter Information Element according to IEEE 802.15.4.

Other suitable selection conditions include whether the communication device has not within a predetermined time span answered to another beacon-request signal, and optionally, if the communication device is aware of a sufficient spectral capacity in its vicinity, or also those communication devices whose address or other suitable identifier are indicated in the selection data, which can also be a group-identifier identifying a group of communication devices.

In another embodiment, the transceiver unit is configured to provide the wireless beacon-request signal including an instruction to any receiving external wireless communication device to cease transmission of wireless communication signals other than the beacon-response signals during a predetermined time span.

For example, a particular transmitted beacon-request signal in accordance with Zigbee or other suitable communication protocol indicates that the beacon-request signal is link to a radioshot, i.e., comprises an instruction to temporarily cease transmission of wireless signals. Adjacent Zigbee communication devices receive the beacon-request signal and temporarily abstain from sending any wireless messages in order to avoid collisions or interferences with the beacon-response signal, which is preferably sent with high transmission power. Hence, while beacon-response signals in known systems do not have a high priority, the priority of the beacon-response signals provided as a response to radioshots is set higher.

In an embodiment wherein the wireless communication protocol is in accordance with IEEE 802.11, a leverage collision avoidance (CSMA/CA) mechanism is advantageously implemented so that other communication devices temporarily cease to transmit signals when signal-quality data, in particular channel state information is being determined, to guarantee that the determined channel state, for example in the form of channel state information (CSI) is free from interferences,

A second aspect of the present invention is formed by a sensing device. The sensing device comprises a signal-quality determination device according to the first aspect of the invention and thus shares any of the advantages thereof or of any of its embodiments.

The sensing device also comprises a presence-determination unit connected to the signal-quality determination unit of the signal-quality determination device and configured to receive the beacon signal-quality data and to determine, using the received beacon signal-quality data a presence or movement of an object or subject in a respective sensing volume determined by a position of the signal-quality sensing determination device and the respective wireless communication device providing the beacon-response signal.

In a particularly advantageous embodiment of a signal-quality determination device, the device-identification information is advantageously used by a network-determination unit that is connected to the receiver unit to determine, using the device-identification information and a list of device-identifiers of those wireless communication devices that form network nodes of the same wireless communication network as the signal-quality determination device, whether a given received beacon-response signal is an inter-network beacon-response signal provided by a neighbor-communication device not belonging to the same wireless communication network as the signal-quality determination device, or an intra-network beacon-response signal provided by a wireless communication device belonging to the same wireless communication network as the signal-quality determination device. The network-determination unit is also configured to provide to the signal-quality determination unit a network-identification signal in the form of an inter-network-identification signal or an intra-network-identification signal, respectively. The signal-quality determination unit is further configured, using the received inter-network identification signal or intra-network-identification signal, respectively, to determine the beacon signal-quality data as inter-network beacon signal-quality data or intra-network beacon signal-quality data respectively.

Thus, this particular embodiment is advantageously configured to determine and provide beacon signal-quality data from beacon-response signals provided by communication devices that are part of the wireless communication network, i.e., as respective intra-network signal-quality signal, and by those that are not part of the wireless communication network i.e., as respective inter-network signal-quality signal. The provision of both types of beacon signal-quality data enables for instance a distinction in terms of relevancy, since typically the communication devices belonging to the same wireless communication network are located closer and provide wireless signals that are received with relatively higher power amount than those signals provided by wireless communication devices belonging to a different wireless communication network.

A particularly advantageous embodiment of the sensing device, further comprises the network determination unit as described above, connected to the receiver unit of the signal-quality determination device.

In an embodiment, the presence-determination unit is further configured to store the received beacon signal-quality signals and to further use the stored beacon signal-quality signals to determine the presence or movement of the object or subject.

In an embodiment the presence or movement determination is performed by using, e.g. by comparing, baseline values indicative of predetermined occupancy scenarios of the sensing volume. In another embodiment, a time evolution of the received inter-network signal-quality signals is monitored or analyzed, so that variations indicative of presence or movement are identified.

In another embodiment, the sensing device comprises a main presence sensing unit configured to perform a presence-sensing function using dedicated presence-sensing messages between the network nodes of the wireless communication network in accordance with a corresponding wireless communication protocol. For instance, specific firmware for presence sensing is stored in the sensing device and in other network nodes which increases the significance and reliability of the presence-sensing function. Further, the sensing device comprises a signal-quality determination device in accordance with the first aspect of the invention that is advantageous for extending a sensing volume using the beacon request/response mechanism described above using this ad-hoc communication channel between the sensing device and other external wireless communication devices, that can be, for instance, legacy, third party or neighboring devices.

An embodiment of the sensing-devices is advantageously configured to detect presence of subjects or objects within sensing volume. Another embodiment is alternatively or additionally configured to detect a movement of a subject or object within the sensing volume. Movement may comprise a displacement of a position within the sensing volume or/and more subtle movements such as breathing, so that an embodiment of the sensing device is configured as a breathing detection device.

According to a third aspect of the present invention, a wireless communication network for sensing presence or movement of a subject or an object within a sensing volume is described. The wireless communication network comprises one or more wireless communication devices that are configured, upon reception of a wireless beacon-request signal as a single-hop broadcast signal in accordance with a wireless communication protocol, to provide a respective beacon-response signal comprising device identification information pertaining to the wireless communication device in accordance with the wireless communication protocol. In the wireless communication network of the third aspect, at least one of the wireless communication devices comprises a signal-quality determination device in accordance with the first aspect of the invention.

The wireless communication network also comprises a presence-determination device configured to receive, and optionally also to store, the beacon signal-quality signals and to determine, using the received, and optionally also the stored, beacon signal-quality signals, a presence or movement of an object or subject in a respective sensing volume determined by a position of the signal-quality sensing determination device and the respective wireless communication device that has provided the beacon-response signal.

In an embodiment, the presence-determination device is a separate device wirelessly connected to the signal-quality determination device. In another embodiment, the wireless communication network comprises at least one sensing device in accordance with the second aspect. Thus, in this embodiment, the signal-quality determination device also includes a presence-sensing determination unit, and is therefore a sensing device in accordance with the invention.

In an embodiment, the wireless communication devices are configured to provide, in response to receiving the beacon-request signal, a beacon-response signal as a broadcast signal. For example, in earlier versions of the IEEE 802.15.4 specification, up to the 2011 release, on which Zigbee PRO in 2.4 GHz is currently based on, the beacon-response signal is sent as a single hop MAC message. According to the relevant specification: “The addressing field shall comprise only the source address fields. The Source PAN Identifier and Source Address fields shall contain the PAN identifier and address, respectively, of the device transmitting the beacon”.

In an alternative embodiment, the wireless communication devices are configured to provide, in response to receiving the beacon-request signal, a beacon-response signal as a unicast signal. For example, the IEEE 802.15.-2015 specification adds a new enhanced message format, in which the enhanced beacon-response signals can be sent as a unicast to the sender of the beacon-request signal. In particular: “if the Enhanced Beacon Frame is sent in response to an Enhanced Beacon Request command:

If a PAN ID is required, then the Destination PAN ID field is set to the value of macPanId and the Source PAN ID field is omitted.

The Destination Address field shall contain the source address contained in the received Enhanced Beacon Request command.”

“The Destination PAN ID field, if present, shall contain either a specific PAN ID or a broadcast PAN ID if macImplicitBroadcast is false.”

“Frames intended for all coordinators shall set the Destination Address field to the broadcast short address. Frames intended for a specific coordinator shall set the Destination field to the coordinator's short address.”

According to a fourth aspect of the present invention, a method for operating a signal-quality determination device is disclosed. The method comprises:
providing, while connected to a wireless communication network, a wireless beacon-request signal as a single-hop broadcast signal in accordance with a wireless communication protocol, the beacon-request signal being indicative of a request to any wireless communication device within a single-hop distance from the signal-quality determination device to provide a respective beacon-response signal that is in accordance with the wireless communication protocol and comprises device-identification information pertaining to the respective wireless communication device;
receiving, any respective beacon-response signals provided by any wireless communication device in response to the beacon-request signal; and
determining and providing beacon signal-quality data indicative of a received-signal quality, particularly of a received-signal strength of the beacon-response signal or of a channel-state of a wireless communication link between that wireless communication device providing the beacon-response signal and a signal-quality sensing determining device.

Therefore, the method of the fourth aspect shares the advantages of the signal-quality determination device of the first aspect of the invention.

According to a fifth aspect of the invention, a method for operating a sensing device is described. The method comprises
preforming any method in accordance with the fourth aspect of the invention;
receiving, and optionally also storing, the beacon signal-quality signals;
determining, using the received and optionally also the stored signal-quality signals, a presence or movement of an object or subject in a respective sensing volume determined by a position of the signal-quality sensing network node and the respective wireless communication device providing the beacon-response signal.

In a particular embodiment, a method in accordance with the fifth aspect also comprises:
determining, using the device-identification information and a list of device-identifiers of those wireless communication devices that form network nodes of the same wireless communication network as the signal-quality determination device, that a given received beacon-response signal is:
an inter-network response signal provided by a neighbor-communication device not belonging to the wireless communication network; or
an intra-network response signal provided by a transmitting wireless communication device belonging to the same wireless communication network as the signal-determination device
determining and providing, using the inter-network identification signal or the intra-network-identification signal, the beacon signal-quality data as inter-network beacon signal-quality data or as intra-network beacon signal-quality data respectively.

According to a sixth aspect of the invention, a method for operating a wireless communication network is disclosed, which comprises:
performing the method of the fifth aspect of the invention; and
providing, upon reception of the wireless beacon-request signal as a single-hop broadcast signal in accordance with a wireless communication protocol, a beacon-response signal comprising, in accordance with the wireless communication protocol, device-identification information pertaining to a respective wireless communication device providing the beacon-response signal.

A seventh aspect of the invention is formed by a computer program comprising instructions which, when executed by a computer, cause the computer to carry out the method of any one of the fourth, fifth or sixth aspects of the invention.

It shall be understood that the signal-quality determination device of claim 1, the sensing device of claim 8, the wireless communication network of claim 9, the method for operating a signal-quality determination device of claim 11, the method for operating a sensing device of claim 12, the method for operating a wireless communication network of claim 14 and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of an embodiment of a signal-quality determination device,

FIG. 2 shows a schematic block diagram of an embodiment of a sensing device,

FIG. 3 shows a schematic diagram of a wireless communication network and a neighbor communication device external to the wireless communication network,

FIG. 4 shows a schematic diagram of another wireless communication network and neighbor communication devices external to the wireless communication network,

FIG. 5 shows a flow diagram of an embodiment of a method for operating a signal-quality determination device,

FIG. 6 shows a flow diagram of an embodiment of a method for operating a sensing device, and

FIG. 7 shows a flow diagram of an embodiment of a method for operating a wireless communication network.

### DETAILED DESCRIPTION OF EMBODIMENTS

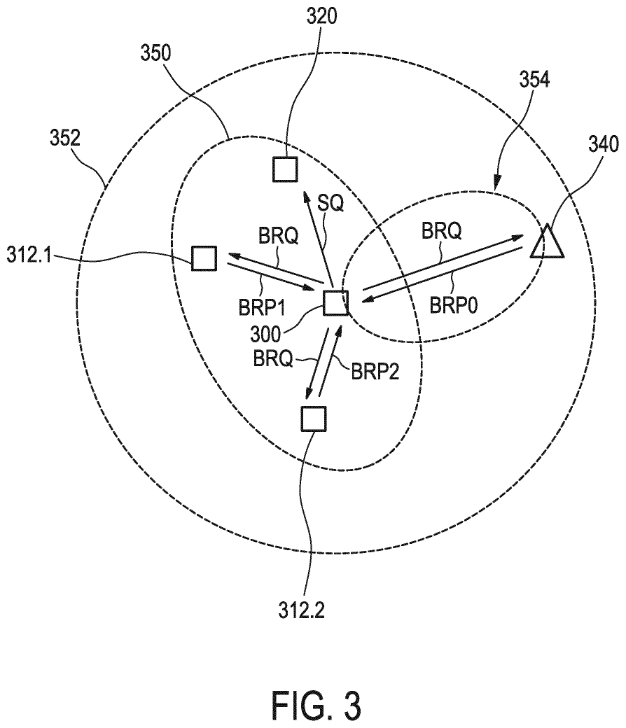

FIG. 1 shows a schematic block diagram of an embodiment of a signal-quality determination device 100. The signal-quality determination device 100 comprises a transceiver unit 102 for communicating, in accordance with a wireless communication protocol, with other wireless communication devices within a wireless communication network 350, as shown in FIG. 3. The transceiver unit comprises a transmitter unit 104 that is configured to provide a wireless beacon-request signal BRQ as a single-hop broadcast signal in accordance with the wireless communication protocol, such as IEEE 802.15.4 or IEEE 802.11. The beacon-request signal is, according to the predetermined communication protocol, indicative of a request to any external wireless communication device, such as devices 312.1, 312.2, and 340 in FIG. 3 that are reachable within a single-hop distance (indicated as 352 in FIG. 3) from the signal-quality determination device to provide a respective beacon-response signal BRP1, BRP2, BRP0 comprising device-identification information in accordance with the wireless communication protocol. The device-identification information pertains to the respective wireless communication device providing the beacon-response signal. The transceiver unit 102 also comprises a receiver unit 106 that is configured to receive, from the external wireless communication devices 312.1, 312.2, 340, any beacon-response signals sent in response to the beacon-request signal.

Also, the signal-quality determination device comprises a signal-quality determination unit 110 that is connected to the receiver unit and configured to determine beacon signal-quality data and to provide a beacon signal-quality signal indicative thereof. The beacon signal-quality data is indicative of a received-signal quality, e.g. of a received-signal strength (RSSI) of the beacon-response signal, or of a channel-state (CSI) of a wireless communication link between the wireless communication device 340 having provided the beacon-response signal and the signal-quality determination device, or of any other suitable characteristic indicative of signal-quality.

The signal-quality determination device 100 optionally also comprises a network-determination unit 108 connected to the receiver unit and configured to determine, using the device-identification information, that the respective received beacon-response signal is an inter-network response signal BRP0 provided by a neighbor-communication device 340 not belonging to the wireless communication network 350, or an intra-network response signal BRP1, BRP2 provided by a transmitting wireless communication device 312.1, 312.2 belonging to the wireless communication network 350 and to provide to the signal-quality determination unit, a network-identification signal indicative thereof in the form of an inter-network-identification signal or an intra-network-identification signal respectively. In this particular signal-quality determination device having the network-determination unit, the signal-quality determination unit is further connected to the network-determination unit and configured, using the received inter-network identification signal or the intra-network-identification signal, to determine the beacon signal-quality data as inter-network beacon signal-quality data or intra-network beacon signal-quality data respectively and to provide, as the beacon signal-quality signal an inter-network signal-quality signal or an intra-network signal-quality signal indicative thereof.

Also, in a particular signal-quality determination device, the transmitter unit optionally comprises a transmission-power control unit 116 connected to the signal-quality determination unit. The signal-quality determination unit is configured to determine a number of beacon-response signals received in response to a given beacon-request signal that has been sent, and the transmission-power control unit is configured to adapt a transmission power amount of the beacon-request signal in dependence on the determined number of beacon-response signals.

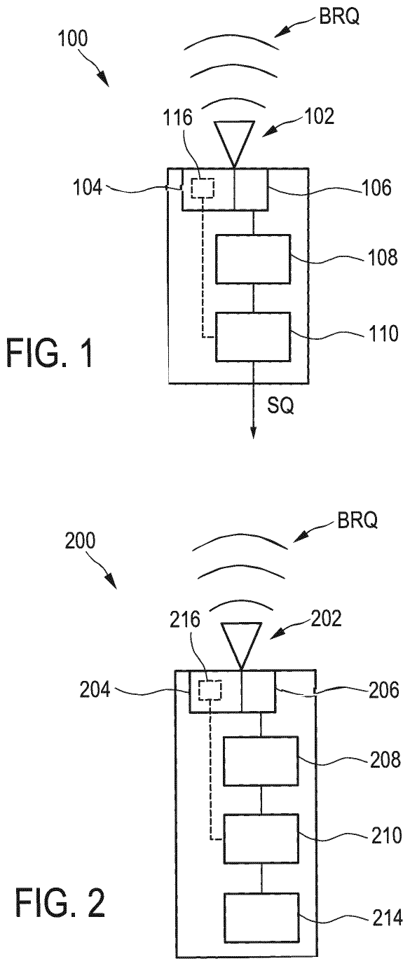

FIG. 2 shows a block diagram of an embodiment of a sensing device 200, for sensing a presence or movement of a subject an object within a given sensing volume. The following discussion will focus on those features distinguishing the sensing device 200 of FIG. 2 from the signal-quality determination device 100 of FIG. 1. Those features shared by the signal-quality determination device 100 and the sensing device 200 will be referred to using the same numeral except for the first digit, which is “1” for the signal-quality determination device 100 of FIGS. 1 and “2” for the sensing device of FIG. 2.

The sensing device 200 comprises all of the units of the signal-quality determination device 100 of FIG. 1. It also comprises a presence-determination unit 214 that is connected to the signal-quality determination unit 210 of the signal-quality determination device and configured to receive the beacon signal-quality signal, or the inter-and/or the intra-network signal-quality signals. It is also configured to determine using the received beacon signal-quality signal, or the inter and/or the intra-network signal-quality signals, a presence or movement of an object or subject in a respective sensing volume determined by a position of the signal-quality sensing network node and the respective wireless communication device, which is either a neighbor communication device that is not part of the wireless communication network or a wireless communication device that is part of the wireless communication network.

FIG. 3 shows a schematic representation of a wireless communication network 350, exemplarily in the form of a wireless lighting arrangement. The lighting arrangement comprises lighting devices that are wirelessly controllable by sensors and/or switches and/or gateway devices such as bridges or access points. The devices of the lighting arrangement are the communication devices 300, 312.1, 312.2 of the wireless communication network and are, for example, located in a room of a building.

The wireless communication devices 312.1, 312.2 are configured, upon reception of a wireless beacon-request signal BRQ as a single-hop broadcast signal in accordance with a wireless communication protocol, to provide a respective beacon-response signal BRP1, BRP2. The beacon-response signal comprises device identification information pertaining to the wireless communication device in accordance with the wireless communication protocol. The wireless communication devices 300 comprises a signal-quality determination device such as signal-quality determination device 100 of FIG. 1.

The wireless communication network also comprises a presence-determination device 320 that is configured to receive the inter-network signal-quality signals SQ and to determine a presence or movement of an object or subject in a sensing volume 354 determined by a position of the signal-quality sensing net and the respective neighbor-wireless communication device using the received signal-quality signals.

The wireless communication network, in addition to performing a wirelessly controllable lighting function, is also configured to perform a presence or movement sensing function, for sensing a presence or a movement of an object or subject within a sensing volume, which suitably covers at least a significant part of the room. This is performed using preferably the beacon signal quality data determined from the respective beacon response signal provided by the wireless communication devices belonging to the wireless communication network 350, and which is referred to as intra-network response signal. This is based on the fact that the determined received signal-quality, e.g. the received-signal strength indicator (RSSI) or the channel-state of a communication link vary as a function of the environment, e.g. of whether or not an object or subject is blocking, and thus absorbing part of the beacon-response signal, which would otherwise reach the signal-quality determination device.

However, the beacon-request signal provided by the signal-quality determination device 300 is also received by the neighbor communication device 340, which does not belong to the same wireless communication network 350. In accordance to the wireless communication protocol, the neighbor communication device 340 has to respond to the reception of the beacon-request signal by providing a beacon-response signal comprising identification information relative to the neighbor communication device 340 itself.

Thus, each of the communication devices within a single-hop range 352 will respond with a beacon-response message which, depending on the type of communication device, and the communication protocol used, can be a unicast or a broadcast signal from that respective communication device to the signal-quality determination device, which is advantageously configured to determine the signal quality (e.g. RSSI, CSI) of the received beacon-response signal. When this process is repeated regularly, variations in these measurements can be used to deduce human movement or presence within a given sensing volume determined by those communication devices responding to the beacon-response signal.

Thus, by allowing determination of signal-quality data from beacon-response signals provided by communication devices not belonging to the wireless communication process, the sensing function is enhanced with extra data.

In an alternative wireless communication arrangement, the signal-quality determination device 300 and the presence-determination device 320 in the form of a presence-determination unit are integrated into a single device and the inter-network signal-quality signal or both the inter- and the intra-network signal-quality signal are provided internally to the presence determination unit.

In a particular wireless communication network, a so called single-sender and single-listener is implemented. This particular implementation is shown in FIG. 3, wherein only the communication device 300 includes a signal-quality determination device. This implementation gives partial coverage of the room, since only signal-quality data from signals provided by devices 312.1 and 312.2 to the signal-quality determination device is available, and not for signals exchanged directly between devices 312.1 and 312.2. This is compensated by the signal-quality data obtained from the communication link established between the signal-quality determination device 300 and the neighbor wireless communication device 340. Using these signal-quality data, for instance over a predetermined time span, a determination of presence/movement in the sensing volume is enabled—either by itself or by transporting the raw or partially processed information to another network node, such as the presence-determination device 320 for (further) processing and decision making.

In this particular implementation, 1+N messages per cycle are required, i.e., 1 beacon-request signal and N beacon-response signals, with N being the number of communication devices within a one hop distance.

In this network arrangement only the communication device 300 needs to have signal-quality determination capabilities, whereas the rest of the communication 312.1, 312.2, 340 can be for instance legacy devices or even third party devices.

Compared to existing RF-based sensing methods, where RF-based sensing is based on sending dedicated messages between communication devices within a wireless communication network and analyzing variation of the received signal strength and that it can only be used with cooperating devices which have this feature implemented and are configured to use it, the signal-quality determination device is not necessarily configured to the reverse signal quality measurement, i.e. how well do communication devices 312.1 and 312.2 hear messages from the signal-quality determination device 300. This can be partly compensated by using the information available, for instance, in the Link Status messages which communication devices 312.1 and 312.2 send out regularly, for example in intervals of 15 seconds.

In this implementation, the communication device 300 receives beacon-response signals from a collection of communication devices, for instance located in the same room, in other rooms in same home, in neighbors houses, or from nodes located on the street. In a particular wireless communication network, the signal-quality determination device is instructed which of those communication links to monitor, and which ones to ignore, if any. The beacons-response signals include identification information of the responding node. For nodes on the same wireless communication network as communication device 300, either the communication device itself or some gateway, or a cloud function, is be aware of the IDs of the other nodes 312.1, 312.2 in the same wireless communication network 350, and thus be able to exploit available metadata on these nodes e.g. information enabling to identify whether the nodes are in the same room, in the same floor, what is their archetype and default RF transmission power amount, etc., for the benefit of the detection algorithm. Thus for all communication devices in the “own” network 350, irrespectively on whether they are legacy devices or not, or of a same manufacturer or third party, useful location information is already derivable, which is used by the determination algorithm to determine how to judge the information from these links for presence/motion detection. For other communication devices, in particular for neighbor communication devices such as device 340 which does not belong to the wireless communication network 350, such information may be lacking and some heuristics are applicable. These may include, for example, information on the manufacturer as derived from the OUI (Organization Unique Identifier) in a MAC address. Other heuristics are the use of the PAN or the RSSI level. Also, in cases where a parallel network, e.g., an HVAC network is also present, and reachable, the ID/location information in that system may be shared with the wireless communication network, for instance during a commissioning time, such that this information is also used for presence/motion detection determination. For instance, information on the location of a particular HVAC device, i.e., whether it is located in the room, or outside the room where the presence sensing function is to be performed.

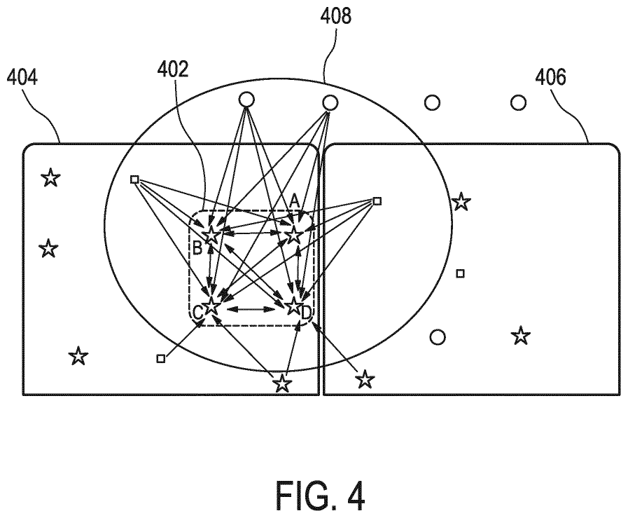

FIG. 4 shows an embodiment of an alternative wireless communication network wherein communication devices A, B, C and D are exemplarily network nodes of a wirelessly controllable lighting arrangement that are located in one room 402 and are configured to perform, in addition to the lighting function, a presence sensing function. Network nodes represented as stars are signal-quality determination devices or sensing devices in accordance with this invention. Network nodes represented as squares are legacy devices which do cannot perform a signal-quality determination function but that are configured to respond to beacon-request signals by providing a respective beacon-response signals. Network nodes represented as circles are third-party nodes. FIG. 4 shows two neighboring houses 404 and 406, wherein room 402 is part of house 404. The network nodes outside the neighboring houses are, for example, street poles which are communication devices capable of communicating with the same communication protocol as the rest of the network nodes shown in FIG. 4. The area represented by circle 408 is the range within which devices receive beacon-request signals from node A. The arrows in the figure indicate communication links between the devices for transmission of beacon-response signals as response to beacon-request signals provided by nodes A, B, C and D.

Since all of the nodes A, B, C and D are signal-quality determination devices or presence devices, they all provide beacon-request signals and receive, from the remaining nodes in the room 402 the corresponding beacon-response signals. That means that, within the room 402, the collection of the nodes A, B C and D, collectively, has similar data for sensing presence or movement as in the existing RF-based sensing methods using dedicated messages. The intra-network signal-quality data is used by a presence-sensing device or a presence-sensing unit associated to a signal-quality determination device to perform the presence-sensing function within the room, as in the case of the existing RF-based sensing methods, but without the need of dedicated messages and using the beacon request/response mechanism already implemented in the wireless communication protocol.

Alternatively, in another wireless communication network, only network node A is configured to provide beacon-request signals. In this wireless communication network, nodes B, C and D are configured to receive the beacon-responses signals sent by the various nodes, either by receiving the beacons-response signals sent as a broadcast signal, or by promiscuous listening, if the beacons-response signals are sent in unicast mode. This does not give the exact same set of connections as in the existing RF-based sensing methods using dedicated messages, but it allows a similar performance.

Also, in another wireless communication network all of the nodes A, B, C and D are configured to provide the beacon-request signals and to determine the signal-quality data of all the beacon-response signals sent between the nodes, either by receiving them directly or by using promiscuous listening.

In all of the alternative wireless communication devices, the nodes A, B, C and D, in addition to receiving the beacon-response signals from the network nodes within the room 402, also receive beacon-response signals from all other nodes within reach that are not in the room 402. The nodes A, B, C and D are also configured to determine beacon signal-quality data indicative of a received-signal strength of the beacon-response signal provided by nodes not belonging to the wireless communication network, or indicative of a channel-state of a wireless communication link between the wireless communication devices, represented as a circle, and the respective network node A, B, C and D, and to provide a respective beacon signal-quality signal indicative thereof.

The additional information in form of respective beacon signal-quality signals obtained from beacon-response signals provided by communication devices that do not belong to the wireless communication network is useful since it provides coverage for a larger area, i.e. it expands the effective sensing volume of the wireless communication network.

In a particular wireless communication network, the increase in number of network messages, i.e. beacon-request and beacon-response signals per “cycle” is compensated by reducing the number of cycles per second. The increase in latency detection for the involved area is at least partially compensated by the earlier detection of presence or movement in the peripheral area, i.e. outside the original sensing volume, e.g. the room 402, but within RF range of the nodes A, B, C or D, hinting at potential presence or movement in the original sensing volume.

In alternative wireless communication network other techniques are additionally or alternatively used to reduce the number of network messages without a significant impact in the performance of the sensing function.

For instance, in a particular wireless communication network, at least one of the signal-quality determination device or devices and/or the sensing devices comprises a transmitter unit that includes a transmission-power control unit connected to the signal quality determination unit and configured to control a transmission power amount of the beacon-request signal in dependence on the determined beacon signal-quality data provided by the signal quality determination unit. The transmission power amount is advantageously controlled to provide beacon-request signals with lower power and thus smaller range during a predetermined first time span and to increase the transmission power amount for providing beacon-request signals with a larger range during a predetermined second time span. This process is then repeated so that the smaller range is scanned more often than the larger range.

Alternatively, or additionally, at least one of the signal-quality determination device or devices and/or the sensing devices has a transceiver unit that is further configured to provide the wireless beacon-request signal including selection data indicative of a predetermined selection-condition to be fulfilled by the external wireless communication device for being eligible to provide the beacon-response signal. By choosing a suitable set of selection-conditions to be applied during different consecutive time spans, the amount of received beacon-response signals is advantageously controlled.

In some wireless communication devices, the wireless communication protocol used allows the beacon-response signal to carry additional information. The network nodes that are capable of determining beacon signal-quality data (e.g. inter and intra-network beacon signal-quality data) are additionally configured add the information they have sensed in the payload of the beacons-response signals they send in response to the beacon-request signal. This means the network nodes A, B, C and D will be aware of the sensing information from the other nodes in the room.

This brings the data exchange similar to the existing RF-based sensing methods using dedicated messages. There is in principle no need to send all data to some central node for the decision making, and each of the sensing devices in the wireless communication network is suitable for acting as a “master” node for determining presence or movement of subjects or objects based on the signals received by all nodes A, B, C and D, plus all data determined from the beacon-response signals received from communication devices belonging to neighboring wireless communication networks, which are not necessarily aware of this sensing function performed by the nodes of the wireless communication network and do not necessarily add the sensing information in the beacon-response signal payload.

An alternative wireless communication network additionally or alternatively uses an IEEE 802.11 communication protocol. For instance, Wi-Fi routers are configured to periodically broadcast “ping” signals. While the communication networks of these Wi-Fi routers are typically password protected, their periodic ping signal can be still received by the any Wi-Fi compatible communication device which is not on the same wireless communication network as the Wi-Fi router. The equivalent of the 802.15.4 Zigbee beacons are called Beacon Frames in Wi-Fi communication networks. A beacon frame is a beacon-response signal in the form of a packet broadcast sent by a Wi-Fi router that is used to synchronize the Wi-Fi wireless network. A beacon frame is used to receive information about the router, including but not limited to SSID and other parameters and it is provided at a predetermined beacon interval which is simply the frequency of the beacon frame i.e., how often the beacon frame is broadcast by the Wi-Fi router.

In a Wi-Fi mesh network, for instance consisting of 3 Google Wi-Fi mesh routers, the multiple Wi-Fi routers on the same Wi-Fi network send out beacon frames, which can be listened to by devices interested in joining the network. In this way, the Wi-Fi node receive beacons from the multiple routers at regular intervals. Using analysis on the signal quality of the received beacons, and variation thereof, presence or movement within a given sensing volume can be determined. For instance, in office buildings, the Wi-Fi infrastructure typically includes several access points to give good coverage of the entire building. A communication device being a sensing device or a signal-quality determination device connected to a presence-sensing unit is configured to receive and analyze the signal quality of the received beacons to deduce presence or motion of a subject or object in a sensing volume.

The signal-quality determination device, for instance as Wi-Fi light is advantageously configured to the one or more Wi-Fi routers to actively solicit a Beacon Frame response by pinging the Wi-Fi router. The Wi-Fi light can additionally be configured to pretend to be a sleepy device to entice the Wi-Fi router to contact it at a determined periodic interval when it is “awake”.

If the signal-quality determination device is not currently in the same wireless communication network as the Wi-Fi router, and does not have the credentials for accessing it, it is advantageously configured to engage in the process to try and get access to the network. This involves sending several messages back and forth between the signal-quality determination device and the Wi-Fi router. The device will not get access, since it does not have the necessary credentials, but the extra exchanged messages can be exploited for quality-signal determination.

If the signal-quality determination device is part of the Wi-Fi network, it can send many (IP) messages to the access point or Wi-Fi router, e.g. regularly requesting the devices' login page (e.g. http://192.168.1.1), sending pings to the routers IP address, etc. Using the signal parameters of the reply (the body of the reply will be discarded), it can improve the presence or motion sensing function since it can send more and longer messages back and forth than the beacons.

In the case of a Wi-Fi mesh network, both a first Wi-Fi Mesh node and a second Wi-Fi Mesh node may transmit Beacon Frames which enables a not-connected Wi-Fi compatible signal-quality determination device in the wireless range of the second mesh node to find the Wi-Fi network. In the traffic indication map of a Wi-Fi beacon frame, the access point is able to inform stations that they have frames waiting for delivery. The signal-quality determination device is advantageously configured to leverage this mechanism to solicit a second Wi-Fi mesh device to contact it, i.e. to provide a beacon-request signal and expect a beacon-response signal in response to the reception of the provided beacon-request signal.

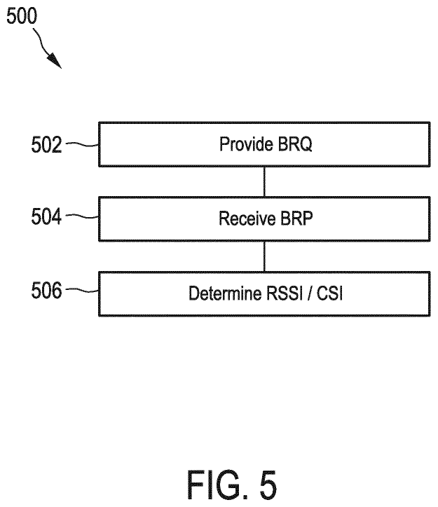

FIG. 5 shows a flow diagram of an embodiment of a method for operating a signal-quality determination device. The method comprises, in a step 502, providing, while connected to a wireless communication network, a wireless beacon-request signal BRQ as a single-hop broadcast signal in accordance with a wireless communication protocol, the beacon-request signal being indicative of a request to any wireless communication device within a single-hop distance from the signal-quality determination device to provide a respective beacon-response signal that is in accordance with the wireless communication protocol and comprises device-identification information pertaining to a respective wireless communication device providing the beacon-response signal. The method also comprises, in a step 504, receiving any respective beacon-response signal provided by any wireless communication device in response to the beacon-request signal. The method also comprises, in a step 506, determining and providing beacon signal-quality data indicative of a received-signal quality, such as, for example a received-signal strength (RSSI) of the inter-network response signal or a channel-state (CSI) of a wireless communication link between the wireless communication device having provided the beacon-response signal and a signal-quality sensing determining device.

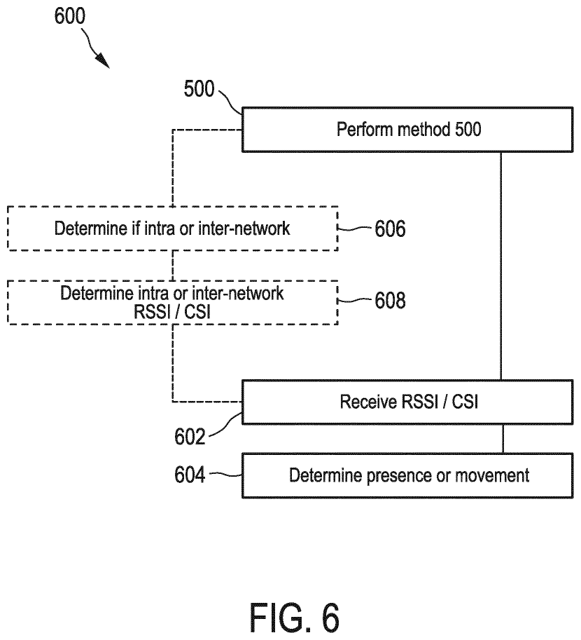

FIG. 6 shows a flow diagram of an embodiment of a method 600 for operating a sensing device. The method 600 comprises performing the steps of method 500 described with respect to FIG. 5. The method 600 further comprises, in a step 602, receiving the beacon signal-quality signals, and, in a step 604, determining, using the received beacon signal-quality signals, a presence or movement of an object or subject in a respective sensing volume determined by a position of the signal-quality sensing network node and the respective wireless communication device having provided the beacon-response signal using the received beacon signal-quality signals.

Optionally, the method also includes, in a step 606, determining, using the device-identification information and a list of device-identifiers of those wireless communication devices that form network nodes of the same wireless communication network as the signal-quality determination device, that a given received beacon-response signal is:
an inter-network response signal provided by a neighbor-communication device not belonging to the wireless communication network; or
an intra-network response signal provided by a transmitting wireless communication device belonging to the same wireless communication network as the signal-determination device;

and, in a step 608, determining and providing, using the inter-network identification signal or the intra-network-identification signal, the beacon signal-quality data as inter-network beacon signal-quality data or as intra-network beacon signal-quality data respectively.

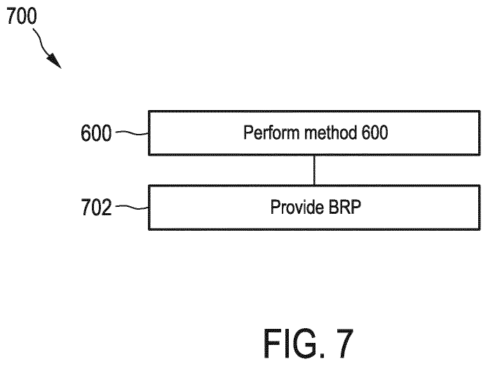

FIG. 7 shows a flow diagram of an embodiment of a method 700 for operating a wireless communication network. The method 700 comprises performing the method of 600 described with reference to FIG. 5. The method 700 further comprises, in a step 702, providing, upon reception of the wireless beacon-request signal BRQ as a single-hop broadcast signal in accordance with a wireless communication protocol, beacon-response signal BRP comprising device-identification information pertaining to a respective wireless communication device that has provided the beacon-response signal.

In summary, the present invention is particularly directed to a signal-quality determination device that comprises a transceiver unit configured to provide a wireless beacon-request signal as a single-hop broadcast signal indicative of a request to any wireless communication device within a single-hop distance from the signal-quality determination device and belonging or not to a wireless communication network to which the signal-quality determination device belongs, to provide a respective beacon-response signal upon reception of the beacon-request signal, and to receive the beacon-response signals. The signal-quality determination device is also configured to determine beacon signal-quality data (SQ) indicative of a received-signal quality, e.g. received-signal strength RSSI of the beacon-response signal, or a channel-state CSI of a respective wireless communication link. The signal-quality determination device is suitable for enabling a reduction of complexity in a radiofrequency based presence or movement sensing function.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A signal-quality determination device, comprising:
a transceiver unit for communicating in a wireless communication network in accordance with a wireless communication protocol, the transceiver unit comprising:
a transmitter unit configured to provide, while connected to the wireless communication network, a wireless beacon-request signal as a single-hop broadcast signal in accordance with the wireless communication protocol, the beacon-request signal being indicative of a request to any wireless communication device within a single-hop distance from the signal-quality determination device to provide a respective beacon-response signal that is in accordance with the wireless communication protocol and comprises device-identification information pertaining to the respective wireless communication device; and
a receiver unit configured to receive any respective beacon-response signal provided by any wireless communication device in response to the beacon-request signal; wherein the beacon-request-response mechanism is implemented in the wireless communication protocol; and
a signal-quality determination unit connected to the receiver unit and configured to determine and provide beacon signal-quality data indicative of a received-signal quality; wherein the received-signal quality comprises a received-signal strength, RSSI, of the beacon-response signal, or of a channel-state, CSI, of a wireless communication link between the wireless communication device having provided the beacon-response signal and the signal-quality determination device, wherein the signal-quality determination unit is further configured to derive beacon signal-quality data irrespectively of whether the beacon response is provided from a wireless communication device within or outside the wireless communication network.

2. The signal-quality determination device of claim 1, wherein
the signal-quality determination unit is configured to determine a number of beacon-response signals received in response to a given beacon-request signal that has been sent;
the transmitter unit comprises a transmission-power control unit (116) connected to the signal-quality determination unit and configured to adapt a transmission power amount of the beacon-request signal in dependence on the determined number of beacon-response signals.

3. The signal-quality determination device of claim 1, further comprising:
a communication-device data ascertainment unit configured to ascertain communication-device data pertaining to those of the wireless communication devices that are within the single-hop distance from the signal-quality determination device;
a beacon-response selection unit, connected to receiver unit and to the communication-device data ascertainment unit and configured to select, in accordance with at least one predetermined selection criterion pertaining to the communication-device data, and provide to the signal quality determination unit only those of the received beacon response signals that fulfil the selection criterion.

4. The signal-quality determination device of claim 1, wherein the transceiver unit is further configured to provide the wireless beacon-request signal including selection data indicative of a predetermined selection condition to be fulfilled by any external wireless communication device for being eligible to provide the beacon-response signal.

5. The signal-quality determination device of claim 1, wherein the transceiver unit is configured to provide the wireless beacon-request signal including an instruction to one or more receiving wireless communication device to cease transmission of wireless communication signals other than the beacon-response signal during a predetermined time span.

6. The signal-quality determination device of claim 1, wherein the transceiver unit is configured to provide the wireless beacon-request signal as a beacon-request in accordance with the IEEE 802.15.4 communication protocol.

7. A sensing device, comprising:
a signal-quality determination device, according to claim 1; and
a presence-determination unit connected to the signal-quality determination unit of the signal-quality determination device and configured:
to receive the beacon signal-quality signal data; and
to determine using the received beacon signal-quality data a presence or movement of an object or subject in a respective sensing volume determined by a position of the signal-quality sensing network node and the respective wireless communication device providing the beacon-response signal.

8. The sensing device of claim 7, further comprising:
a network-determination unit connected to the receiver unit and configured
to determine, using the device-identification information and a list of device-identifiers of those wireless communication devices that form network nodes of the same wireless communication network as the signal-quality determination device, that a given received beacon-response signal is
an inter-network beacon-response signal provided by a neighbor-communication device not belonging to the same wireless communication network as the signal-quality determination device, or
an intra-network beacon-response signal provided by a wireless communication device belonging to the same wireless communication network as the signal-quality determination device, and
to provide to the signal-quality determination unit a network-identification signal in the form of an inter-network-identification signal or an intra-network-identification signal, respectively; and wherein
the signal-quality determination unit is further configured, using the received inter-network identification signal or intra-network-identification signal, respectively, to determine and provide the beacon signal-quality data as inter-network beacon signal-quality data or intra-network beacon signal-quality data respectively.

9. A wireless communication network for sensing presence or movement of a subject or an object within a sensing volume; the wireless communication network comprising:
one or more wireless communication devices configured, upon reception of a wireless beacon-request signal as a single-hop broadcast signal in accordance with a wireless communication protocol, to provide a respective beacon-response signal comprising device identification information pertaining to the wireless communication device in accordance with the wireless communication protocol, wherein at least one of the wireless communication devices comprises a signal-quality determination device in accordance with claim 1; and
a presence-determination device-configured to receive the beacon signal-quality signal and to determine, using the received beacon signal-quality signals, a presence or movement of an object or subject in a respective sensing volume determined by a position of the signal-quality determination device and the respective wireless communication device providing the beacon-response signal.

10. The wireless communication network of claim 9, wherein at least one of the wireless communication devices comprises a sensing device.

11. A method for operating a signal-quality determination device, the method comprising:
providing a wireless beacon-request signal as a single-hop broadcast signal in accordance with a wireless communication protocol, the beacon-request signal being indicative of a request to any wireless communication device within a single-hop distance from the signal-quality determination device to provide a respective beacon-response signal that is in accordance with the wireless communication protocol and comprises device-identification information pertaining to the respective wireless communication device; wherein the beacon-request-response mechanism is implemented in the wireless communication protocol;
receiving any respective beacon-response signals provided by any wireless communication device in response to the beacon-request signal; and
determining and providing beacon signal-quality data indicative of a received-signal quality; wherein the received-signal quality comprises a received-signal strength, RSSI, of the beacon-response signal, or of a channel-state, CSI, of a wireless communication link between the wireless communication device having provided the beacon-response signal and the signal-quality determination device, wherein beacon signal-quality data has been derived irrespectively of whether the beacon response is provided from a wireless communication device within or outside the wireless communication network.

12. A method for operating a sensing device, comprising:
preforming the method of claim 11;
receiving the beacon signal-quality signal;
determining, using the received beacon signal-quality signals, a presence or movement of an object or subject in a respective sensing volume determined by a position of the signal-quality sensing network node and the respective wireless communication device providing the beacon-response signal.

13. The method of claim 12, further comprising
determining, using the device-identification information and a list of device-identifiers of those wireless communication devices that form network nodes of the same wireless communication network as the signal-quality determination device, that a given received beacon-response signal is:
an inter-network response signal provided by a neighbor-communication device not belonging to the wireless communication network; or
an intra-network response signal provided by a transmitting wireless communication device belonging to the same wireless communication network as the signal-determination device
determining and providing, using the inter-network identification signal or the intra-network-identification signal, the beacon signal-quality data as inter-network beacon signal-quality data or as intra-network beacon signal-quality data respectively.

14. A method for operating a wireless communication network, comprising:
performing the method of claims 12;
providing, upon reception of the wireless beacon-request signal as a single-hop broadcast signal in accordance with a wireless communication protocol, a beacon-response signal comprising, in accordance with the wireless communication protocol, device-identification information pertaining to a respective wireless communication device providing the beacon-response signal.

15. A non-transitory computer readable medium comprising computer executable instructions that, when executed, perform at least the method of claim 11.
